(19) United States
(12) Patent Application Publication
(10) Pub. No.: US 2016/0309233 A1
(43) Pub. Date: Oct. 20, 2016

(54) VIDEO DISTRIBUTION AND MEDIA RESOURCE SYSTEM INTERACTION METHOD AND SYSTEM

(71) Applicants: LECLOUD COMPUTING CO., LTD., Beijing (CN); LE HOLDINGS (BEIJING) CO., LTD., Beijing (CN)

(72) Inventors: Junshi LIU, Chaoyang District, Beijing (CN); Chao LI, Chaoyang District, Beijing (CN); Bo XING, Chaoyang District, Beijing (CN); Dalei BAO, Chaoyang District, Beijing (CN); Xiaoqing WANG, Chaoyang District, Beijing (CN)

(21) Appl. No.: 15/101,940

(22) PCT Filed: Nov. 26, 2014
(86) PCT No.: PCT/CN2014/092309

§ 371 Date: Jun. 6, 2016

(30) Foreign Application Priority Data
Dec. 17, 2013 (CN) 201310695914.X

(51) Int. Cl. H04N 21/488; H04N 21/24; H04N 21/231

(52) U.S. Cl. CPC H04N 21/4882; H04N 21/23109; H04N 21/2407

(57) ABSTRACT

The present disclosure provides a method and system for distributing a video and interacting with a media resource system. The method includes: distributing and storing a transcoded video, obtaining a distributed storage address of the video and generating a notification message using the obtained address and adding the notification message to a queue of messages; and searching for and distributing the video corresponding to the distributed storage address in the notification message upon monitoring that the notification message in the queue of messages is read by the media resource system, if the distribution of the video is finished, deleting the notification message corresponding to the video from the queue of messages, or if the distribution of the video is interrupted, putting the notification message corresponding to the video at the end of the queue of messages to wait for processing. Present invention solves the issue that media resource system interaction.

### CROSS-REFERENCE TO RELATED APPLICATIONS

This application claims the benefit of Chinese Patent Application No. 201310695914.X, filed with the State Intellectual Property Office of People's Republic of China on Dec. 17, 2013 and titled “Method and system for distributing a video and interacting with a media resource system”, which is hereby incorporated by reference in its entirety.

### FIELD OF TECHNOLOGY

The present invention relates to a field of video data interaction, and more particularly to a method and system for distributing a video and interacting with a media resource system.

### BACKGROUND

In a prior art, a video website transmits and plays various video products through a media resource system in the video website so that people can access the corresponding video website through computer terminals, mobile terminals, or Internet-enabled TV terminals to watch the various videos.

Particularly not all the video formats may be suitable for transmission and playing over the Internet, for example, the “.flv” format is suitable for transmission to and playing on a TV terminal, and the “.mp4” format is suitable for transmission to and playing through computer and mobile terminal networks. There are different video formats of the different videos, so the video website performs respective transcoding tasks through respective transcoding servers or transcoding systems to transcode the videos to thereby convert the various videos into a format suitable for playing over the Internet.

For a video on an Internet video website, the video (referred to a video product) transcoded by a transcoding server needs to be distributed to the media resource system through a distribution server, e.g., a Content Delivery Network (CDN), etc., so that the video can be presented to users in different regions over the Internet. Then the distribution server needs to interact with the media resource system for the distributed video product.

At present the distribution server interacts with the media resource system using the Hypertext Transfer protocol (HTTP), but this HTTP interaction mode has the following drawbacks:

If the video product is distributed in a corresponding distribution thread, the video may fail to be distributed due to overtime distribution, an interruption of the Internet, a failure of the media resource system, and other reasons, so the current video product will be distributed repeatedly in the thread all the time, and other undistributed video products will not be further distributed until the current video product is distributed successfully, so that the subsequent video products may be piled up, thus seriously degrading the efficiency of distribution.

### SUMMARY

In view of this, the invention is intended to provide a method and system for distributing a video and interacting with a media resource system so as to solve the issue of distributing a video and interacting with a media resource system.

In order to solve the technical problem above, the invention discloses a method for distributing a video and interacting with a media resource system, the method includes:

distributing and storing a transcoded video, obtaining a distributed storage address of the video and generating a notification message using the obtained address, and adding the notification message to a queue of messages; and

searching for and distributing the video corresponding to the distributed storage address in the notification message upon monitoring that the notification message in the queue of messages is read by the media resource system, wherein:

if the distribution of the video is finished, deleting the notification message corresponding to the video from the queue of messages, or

if the distribution of the video is interrupted, putting the notification message corresponding to the video at the end of the queue of messages to wait for processing.

Preferably the method further includes:

monitoring an amount of data in the queue of messages, and adding the notification messages received beyond a preset largest amount of data stored in the queue of messages to a backup queue of messages upon monitoring a larger amount of data in the queue of messages than the preset largest amount of data stored in the queue of messages.

Preferably the queue of messages is a queue of messages stored in a queue storage device in a distributed storage manner; and the backup queue of messages is a backup queue of messages stored in advance in the queue storage device.

In order to solve the technical problem above, the invention further discloses a system for distributing a video and interacting with a media resource system, the system includes: a distributing and storing unit, a monitoring unit, and a searching and processing unit, wherein:

the distributing and storing unit is configured to distribute and store a transcoded video, to obtain a distributed storage address of the video and to generate a notification message using the obtained address, and to add the notification message to a queue of messages.

the monitoring unit is configured to monitor the queue of messages, and to generate and send a search instruction to the searching and processing unit upon monitoring that the notification message in the queue of messages is read by the media resource system.

the searching and processing unit is configured to search for and distribute the video corresponding to the distributed storage address in the notification message upon reception of the search instruction, wherein if the distribution of the video is finished, the notification message corresponding to the video is deleted from the queue of messages, or if the distribution of the video is interrupted, the notification message corresponding to the video is put at the end of the queue of messages to wait for processing.

Preferably the monitoring unit is further configured:

to monitor an amount of data in the queue of messages, and to add the notification messages received beyond the preset largest amount of data stored in the queue of messages to a backup queue of messages upon monitoring a larger amount of data in the queue of messages than the preset largest amount of data stored in the queue of messages.

Preferably the queue of messages is a queue of messages stored in a queue storage device in a distributed storage manner; and the backup queue of messages is a backup queue of messages stored in advance in the queue storage device.

In order to solve the technical problem above, the invention further discloses a system for distributing a video and interacting with a media resource system, the system comprises:

one or more processors; and

a memory;

wherein one or more programs are stored in the memory, and when executed by the one or more processors, the one or more programs cause the one or more processors to:

distribute and store a transcoded video, obtain a distributed storage address of the video, generate a notification message using the obtained address, and add the notification message to a queue of messages; and

search for and distribute the video corresponding to the distributed storage address in the notification message upon monitoring that the notification message in the queue of messages is read by the media resource system, wherein:

if the distribution of the video is finished, deleting the notification message corresponding to the video from the queue of messages, or

if the distribution of the video is interrupted, putting the notification message corresponding to the video at the end of the queue of messages to wait for processing.

Preferably, the one or more processors are configured to:

monitor an amount of data in the queue of messages, and add the notification messages received beyond a preset largest amount of data stored in the queue of messages to a backup queue of messages upon monitoring a larger amount of data in the queue of messages than the preset largest amount of data stored in the queue of messages.

Preferably, the queue of messages is a queue of messages stored in a queue storage device in a distributed storage manner; and the backup queue of messages is a backup queue of messages stored in advance in the queue storage device.

As compared with the prior art, the method and system for distributing a video and interacting with a media resource system according to the invention achieve the following effects:

1) In the invention, the video products are distributed and stored, the notification messages including the distributed storage addresses are generated, the notifications messages are obtained by the media resource system itself in the queue of messages, and the stored video products are further transmitted, thus altering the direct distribution of the videos and interaction with the media resource system to thereby remove the dependence upon a response speed of the media resource system, and the need of repeated distribution of the videos, for which the interaction fails, so as to address in effect the distribution of the videos and interaction with the media resource system.

2) In the invention, the state of the storage capacity of the queue of messages can be monitored in real time to thereby enable the backup queue of messages in a timely manner so as to avoid the notification messages from being lost due to the saturated storage capacity of the queue of messages.

Of course, any product in which the invention is embodied may not necessarily achieve all the technical effects above.

### BRIEF DESCRIPTION OF THE DRAWINGS

The drawings described here are intended to provide further understanding of the invention, and constitute a part of the invention, and the exemplary embodiments of the invention and the description thereof are intended to set forth the invention but not to limit the invention unduly. In the drawings:

FIG. 1 is a flow chart of a method for distributing a video and interacting with a media resource system according to a first embodiment of the invention;

FIG. 2 is a flow chart of a method for distributing a video and interacting with a media resource system according to a second embodiment of the invention;

FIG. 3 is a flow chart of steps in a particular application a method for distributing a video and interacting with a media resource system according to a third embodiment of the invention; and

FIG. 4 is a structural block diagram of a system for distributing a video and interacting with a media resource system according to a fourth embodiment of the invention.

### DESCRIPTION OF THE EMBODIMENTS

Some terms as used in the description and the claims refer to specific components. Those skilled in the art can appreciate that the same component may be denominated by hardware manufactures using different names. In the description and the claims, the components will not be distinguished from each other using their different names, but they will be functionally distinguished from each other. “Include/comprise” as referred to throughout the description and the claims are open terms and thus shall be interpreted as “include/comprise but will not be limited to”. “Substantially” refers to the possibility for those skilled in the art to solve the technical problem in some error range, which is an acceptable error range, to substantially achieve the technical effects. Moreover the term “couple” here encompasses any direct and indirect electrical coupling means. Thus if a first element is described in this context as being coupled a second element, the first element can be electrically coupled with the second element directly, or indirectly through another element or coupling means. The following description will illustrate preferred embodiments of the invention, but the description is intended to illustrate a general principle of the invention instead of limiting the scope of the invention. The claimed scope of the invention shall be as defined in the appended claims.

### First Embodiment

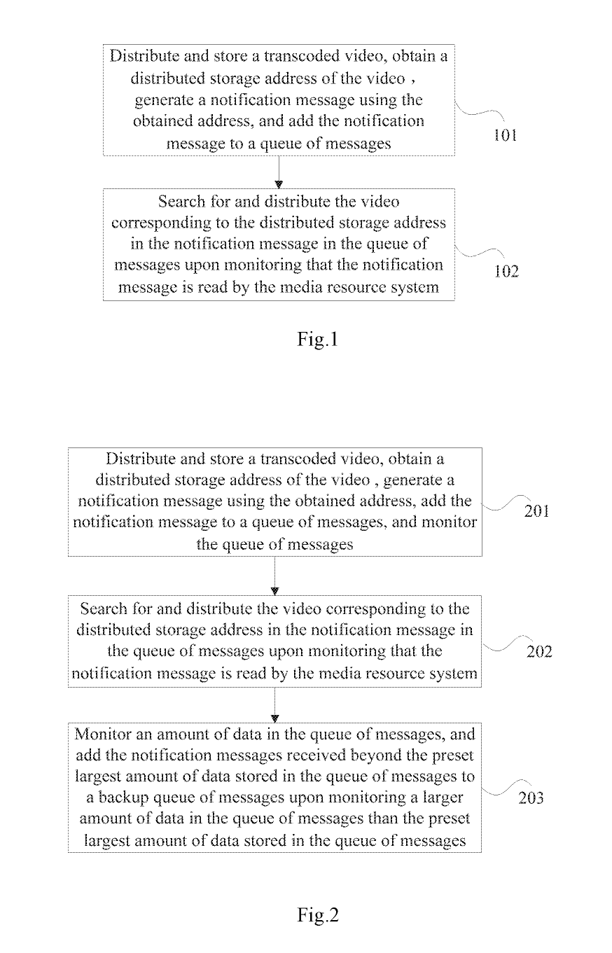

As illustrated in FIG. 1 showing a method for distributing a video and interacting with a media resource system according to a first embodiment of the invention, the method includes:

The step 101 is to distribute and store a transcoded video, to obtain a distributed storage address of the video and to generate a notification message using the obtained address, and to add the notification message to a queue of messages.

In the step 101, the video transcoded into a video product in one of various formats suitable for playing needs to be distributed to a media resource system over the Internet for playing of the video. The video can be distributed (e.g., synchronously or asynchronously) through a corresponding distribution server in a CDN network, and of course the invention will not be limited any particular video distribution mode.

It shall be noted the video product, into which the video is transcoded, distributed successfully through the distribution server of the CDN network is stored in a database or a storage device of a corresponding network server of the CDN network, and the storage address of the video is embodied in the form of a storage path, so that in the step 101, a domain name of the network server is obtained together with the storage path of the video product stored in the network server, and the notification message is generated.

The queue of messages in the step 101 can particularly be a queue of messages stored in a queue storage device in a distributed storage manner, where the queue storage device is particularly a memory or another flash storage device in the network server, in which the queue is stored.

The step 102 is to search for and distribute the video corresponding to the distributed storage address in the notification message in the queue of messages upon monitoring that the notification message is read by the media resource system.

In the step 102, the queue of messages is set so that the distribution server will not directly interact with the media resource system (which can particularly a media resource system) using the HTTP, but the corresponding distribution server will add the storage address of the distributed and stored video product to the corresponding queue of messages in the notification message instead of sending the video product directly to the media resource system, and the queue storage device in which the message queue is stored receives a read access of the media resource system, where after the media resource system reads one of the notification messages in the queue storage device, the queue storage device further distributes the video product corresponding to the distributed storage address in the notification message to the media resource system. As such the distribution server will not wait for a response of the media resource system, but distribute and store the video product directly upon reception of the video product, so that the distributed video products will not be piled up in the distribution server.

### Second Embodiment

As illustrated in FIG. 2 showing a method for distributing a video synchronously/asynchronously according to a second embodiment of the invention, the method includes:

The step 201 is to distribute and store a transcoded video, to obtain a distributed storage address of the video and to generate a notification message using the obtained address, and to add the notification message to a queue of messages.

Particularly in a real application, videos generally transcoded by tens or hundreds of transcoding servers in parallel, each of which can perform several or dozens of transcoding tasks concurrently, thus resulting in a large number of transcoded video products; and in order to improve the efficiency of distribution and to avoid a large number of video products from being piled up in the distribution server, the transcoded video products are distributed and stored through distribution servers in a CDN network synchronously, that is, the different transcoded video products in the distribution servers are distributed and stored concurrently. Of course, the invention will not be limited to any particular video distribution mode.

The step 202 is to search for and distribute the video corresponding to the distributed storage address in the notification message in the queue of messages upon monitoring that the notification message is read by the media resource system.

In the step 202, the video corresponding to the distributed storage address in the notification message is searched for and distributed particularly by searching for and distributing the video corresponding to the distributed storage address in the notification message, and if the distribution of the video is finished, deleting the notification message corresponding to the video from the queue of messages; or if the distribution of the video is interrupted, putting the notification message corresponding to the video at the end of the queue of messages to wait for processing.

It shall be noted that the distribution of the distributed and stored video product to the media resource system still may be interrupted (that is, the distribution may fail) due to a network delay, an overtime response, or other reasons, and if the video product, the distribution of which is interrupted is distributed repeatedly in the distribution-failure repeating mechanism all the time, the subsequent video products can not be distributed in a timely manner to the media resource system for playing, so, in the step 202, the notification message corresponding to the video product, the distribution of which is interrupted is put at the end of the queue of messages to further wait for processing, so that the media resource system can read the subsequent notification messages in the queue of messages, and operate to distribute the videos accordingly. If the media resource system reads the notification message of the video, and distributes the video but fails again, the notification message will be put again at the end of the queue of messages to wait for processing until the video is distributed successfully to the media resource system, and the notification message corresponding thereto will be deleted.

The step 203 is to monitor an amount of data in the queue of messages, and to add the notification messages received beyond a preset largest amount of data stored in the queue of messages to a backup queue of messages upon monitoring a larger amount of data in the queue of messages than the preset largest amount of data stored in the queue of messages.

In the step 203, the queue of messages is stored in a corresponding queue storage device, and a limited amount of data are stored in the queue of messages, so the storage capacity of the queue of messages will be saturated by the overflowing notification message, and if the storage capacity of the queue of messages is saturated, the subsequent notification messages can not be added to the queue of messages, thus losing the notification messages. Thus in the step 203, the amount of data of the notification messages in the queue of messages is monitored, and if the amount of data of the notification messages is larger than the preset largest amount of data stored in the queue of messages, the notification message will be added to the backup queue of messages.

Here the backup queue of messages can be particularly stored in the queue storage device, and the storage capacity of the backup queue of messages is larger or equal to the storage capacity of the queue of messages. Of course, preferably the backup queue of messages is stored in advance in a large-capacity hard disk or database of the distribution server, so that after the storage capacity of the queue of messages is saturated, the notification messages received beyond the preset largest amount of data stored in the queue of messages can be added from the queue of messages to the backup queue of messages to thereby avoid the notification message from being lost.

### Third Embodiment

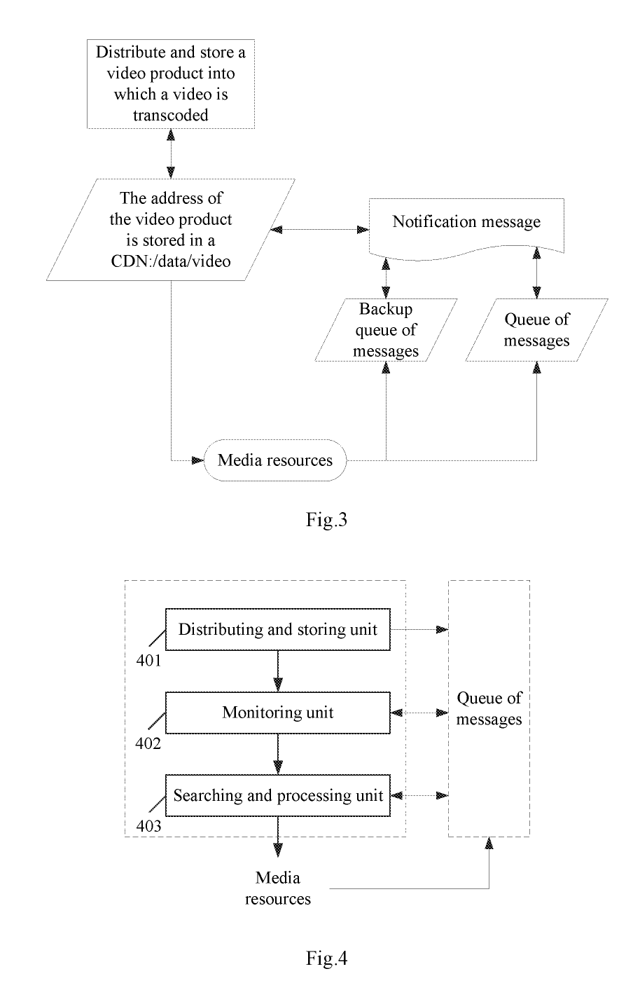

A particular application of the method for distributing a video and interacting with a media resource system will be described below in details with reference to FIG. 3.

For example, FIG. 3 illustrates a flow of interaction between one distribution server and a media resource system in a real application, where the distribution server is coupled with a corresponding transcoding server (not illustrated in FIG. 3), and receives videos A to H transcoded by the transcoding server.

The distribution server interacts with the media resource system particularly as follows:

The step 1 is to distribute and store the videos A to H respectively in a network server in a CDN, at the /data/video positions in the CDN network server, to obtain distributed storage addresses of the videos A to H respectively (particularly /data/video/A, /data/video/B, . . . , and /data/video/H), to generate notification messages corresponding to the respective videos (for the sake of a convenient representation, a notification message A, a notification message B, . . . , and a notification message H), and to add the notification messages to a queue of messages.

The step 2 is to search for and distribute the video corresponding to the distributed storage address in any one of the notification messages of the videos A to H in the queue of messages upon monitoring that the notification message is read by the media resource system.

The step 3 is to monitor the amount of data in the queue of messages, and add to a backup queue of messages the notification messages received beyond the preset largest amount of data stored in the queue of messages upon monitoring a larger amount of data in the queue of messages than the preset largest amount of data stored in the queue of messages.

Particularly:

In the step 1, in order to improve the efficiency of distribution and to avoid a large number of video products from being piled up in the distribution server, the distribution server distributes and stores the videos A to H synchronously, and of course, the largest number of videos distributed by the distribution server concurrently depends upon a processing capacity of the server, so the invention will not be limited thereto.

The notification messages include a domain name of the network server in addition to the storage addresses of the videos A to H in the network server because there may be a number of different network servers deployed in the CND network, each of which is provided with a unique domain name, so the notification messages further include the domain name, that is, the distributed storage address in the notification message is fully represented as http://www.fuwuqi.com/data/video/A, wherein http://www.fuwuqi.com/ represents the domain name of the network server.

In the step 2, it shall be noted that the notification messages are arranged in certain order in the queue of messages, for example, they can be arranged in an order of the names A to H of the videos, that is, the notification message A, the notification message B, . . . , and the notification message H.

Thus the media resource system firstly reads the notification message A, and at this time, the distributed storage address of the video A in the notification message A is extracted as http://www.fuwuqi.com/data/video/A, and the corresponding video A is searched using the distributed storage address for and then distributed to the media resource system. The media resource system further reads the notification message B, and the same process as the video A is performed; and if the distribution of the video B to the media resource system is interrupted, the notification message B corresponding to the video B is put at the end of the queue of messages, and the media resource system further reads the notification message C, and so on until all the notification messages in the queue of messages are read by the media resource system.

In the step 3, if the amount of data in the queue of messages in which the notification message G is stored is larger than the preset largest amount of data stored in the queue of messages, the notification message H can not be put in the queue of messages, so the backup queue of messages is enabled, and the notification message H is put in the backup queue of messages.

### Fourth Embodiment

As illustrated in FIG. 4, there is a system for distributing a video and interacting with a media resource system according to a fourth embodiment of the invention, where the system includes a distributing and storing unit 401, a monitoring unit 402, and a searching and processing unit 403, wherein:

The distributing and storing unit 401 coupled with the monitoring unit 402 is configured to distribute and store a transcoded video, to obtain a distributed storage address of the video and to generate a notification message using the obtained address, and to add the notification message to a queue of messages.

The monitoring unit 402 coupled with the distributing and storing unit 401 and the searching and processing unit 403 is configured to monitor the queue of messages, and to generate and send a search instruction to the searching and processing unit 403 upon monitoring that the notification message in the queue of messages is read by the media resource system.

The searching and processing unit 403 coupled with the monitoring unit 402 is configured to search for and distribute the video corresponding to the distributed storage address in the notification message upon reception of the search instruction.

Particularly the distributing and storing unit 401 can distribute and store the videos by distributing the videos synchronously through corresponding distribution servers in a CDN network, and storing the video products in databases or storage devices of corresponding network servers of the CDN network after the videos are distributed successfully, where the storage addresses of the videos are embodied in the form of a storage path, so that the distributing and storing unit 401 obtains domain names of the network servers together with the storage paths of the video products stored in the network servers, and generates the notification messages.

The queue of messages can particularly be a queue of messages stored in a queue storage device in a distributed storage manner, where the queue storage device is particularly a memory or another flash storage device in the network server, in which the queue is stored.

The monitoring unit 402 is further configured to monitor the amount of data in the queue of messages, and to add the notification messages received beyond the preset largest amount of data stored in the queue of messages to a backup queue of messages upon monitoring a larger amount of data in the queue of messages than the preset largest amount of data stored in the queue of messages.

Particularly the queue of messages is stored in a corresponding queue storage device, and a limited amount of data are stored in the queue of messages, so the storage capacity of the queue of messages will be saturated by the overflowing notification message, and if the storage capacity of the queue of messages is saturated, the subsequent notification messages can not be added to the queue of messages, thus losing the notification messages. Thus the monitoring unit 402 monitors the amount of data of the notification messages in the queue of messages, and if the amount of data of the notification messages is larger than the preset largest amount of data stored in the queue of messages, the notification message will be added to the backup queue of messages.

Here the backup queue of messages is particularly a backup queue of messages stored in advance in the queue storage device, and the storage capacity of the backup queue of messages is larger or equal to the storage capacity of the queue of messages. Of course, preferably the backup queue of messages is stored in advance in a large-capacity hard disk or database of the distribution server, so that after the storage capacity of the queue of messages is saturated, the notification message received beyond the preset largest amount of data stored in the queue of messages can be added from the queue of messages to the backup queue of messages to thereby avoid the notification message from being lost.

The searching and processing unit 403 is configured to search for and distribute the video corresponding to the distributed storage address in the notification message, and if the distribution is finished, to delete the notification message corresponding to the video from the queue of messages; or if the distribution is interrupted, to put the notification message corresponding to the video at the end of the queue of messages to wait for processing.

It shall be noted that the distribution of the distributed and stored video product to the media resource system still may be interrupted due to a network delay, an overtime response, or other reasons, and if the video product, the distribution of which is interrupted is distributed repeatedly in the distribution-failure repeating mechanism all the time, the subsequent video products can not be distributed in a timely manner to the media resource system for playing, so the searching and processing unit 403 puts the notification message corresponding to the video product, the distribution of which is interrupted, at the end of the queue of messages to further wait for processing, so that the media resource system can read the subsequent notification messages in the queue of messages, and operate to distribute the videos accordingly. If the media resource system reads the notification message of the video, and distributes the video but fails again, the notification message will be put again at the end of the queue of messages to wait for processing until the video is distributed successfully to the media resource system, and the notification message corresponding thereto will be deleted.

Since the method of the invention has been described in details with respect to the embodiments thereof, a detailed description of the system according to the embodiment of the invention, corresponding to the method of the invention will be omitted here instead of being repeated. For details about the system of the invention, reference can be made to the embodiment of the method of the invention, so a repeated description thereof will not be made here.

As compared with the prior art, a method and system for distributing a video and interacting with a media resource system according to the invention achieves the following effects:

1) In the invention, the video products are distributed and stored, the notification messages including the distributed storage addresses are generated, the notifications messages are obtained by the media resource system itself in the queue of messages, and the stored video products are further transmitted, thus altering the direct distribution of the videos and interaction with the media resource system to thereby remove the dependence upon a response speed of the media resource system, and the need of repeated distribution of the videos, for which the interaction fails, so as to address in effect the distribution of the videos and interaction with the media resource system.

2) In the invention, the state of the storage capacity of the queue of messages can be monitored in real time to thereby enable the backup queue of messages in a timely manner so as to avoid the notification messages from being lost due to the saturated storage capacity of the queue of messages.

It shall be further noted that the term “include/comprise” or any other variants thereof are intended to encompass nonexclusive inclusion so that a process, a method, an article or a device including a series of elements includes both those elements and one or more other elements which are not listed explicitly or one or more elements inherent to the process, the method, the article or the device. Unless stated otherwise, an element being defined in the sentence “include/comprise a(n) . . . ” will not exclude the presence of one or more additional identical element in the process, the method, the article or the device including the element.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The foregoing disclosure is merely illustrative of the embodiments of the invention but not to limit the invention. Those skilled in the art can make various modifications and variations. Any modifications, equivalents, adaptations, etc., made without departing from the spirit and principle of the invention shall fall into the scope of the claims of the invention.

1-6. (canceled)

7. A method for distributing a video and interacting with a media resource system, the method comprises:
distributing and storing a transcoded video, obtaining a distributed storage address of the video and generating a notification message using the obtained address, and adding the notification message to a queue of messages; and
searching for and distributing the video corresponding to the distributed storage address in the notification message upon monitoring that the notification message in the queue of messages is read by the media resource system, wherein:
if the distribution of the video is finished, deleting the notification message corresponding to the video from the queue of messages, or
if the distribution of the video is interrupted, putting the notification message corresponding to the video at the end of the queue of messages to wait for processing.

8. The method for distributing a video and interacting with a media resource system according to claim 7, wherein the method further comprises:
monitoring an amount of data in the queue of messages, and adding the notification messages received beyond a preset largest amount of data stored in the queue of messages to a backup queue of messages upon monitoring a larger amount of data in the queue of messages than the preset largest amount of data stored in the queue of messages.

9. The method for distributing a video and interacting with a media resource system according to claim 8, wherein:
the queue of messages is a queue of messages stored in a queue storage device in a distributed storage manner; and
the backup queue of messages is a backup queue of messages stored in advance in the queue storage device.

10. A system for distributing a video and interacting with a media resource system, the system comprises:
one or more processors; and
a memory;
wherein one or more programs are stored in the memory, and when executed by the one or more processors, the one or more programs cause the one or more processors to:
distribute and store a transcoded video, obtain a distributed storage address of the video, generate a notification message using the obtained address, and add the notification message to a queue of messages; and
search for and distribute the video corresponding to the distributed storage address in the notification message upon monitoring that the notification message in the queue of messages is read by the media resource system, wherein:
if the distribution of the video is finished, deleting the notification message corresponding to the video from the queue of messages, or
if the distribution of the video is interrupted, putting the notification message corresponding to the video at the end of the queue of messages to wait for processing.

11. The system for distributing a video and interacting with a media resource system according to claim 10, wherein the one or more processors are configured to:
monitor an amount of data in the queue of messages, and add the notification messages received beyond a preset largest amount of data stored in the queue of messages to a backup queue of messages upon monitoring a larger amount of data in the queue of messages than the preset largest amount of data stored in the queue of messages.

12. The system for distributing a video and interacting with a media resource system according to claim 11, wherein:
the queue of messages is a queue of messages stored in a queue storage device in a distributed storage manner; and
the backup queue of messages is a backup queue of messages stored in advance in the queue storage device.
